(19) United States
(12) Patent Application Publication
(10) Pub. No.: US 2012/0261052 A1
(43) Pub. Date: Oct. 18, 2012

(54) METHOD OF REHABILITATING OR REMEDIATING STRUCTURES

(75) Inventors: Jason Ian Lecoultre, Bedford (AU); Jasper Gerrit Hendrik Bouwmeester, Mt. Lawley (AU); Laurence John Walker, Karrinyup (AU); Colin Robert McCullough, Mt. Lawley (AU); Andrew George Petrow, Carlisle (AU)

(73) Assignee: Industrial Composites Engineering Pty Ltd, Malaga (AU)

(21) Appl. No.: 13/501,386

(22) PCT Filed: Oct. 12, 2010
(86) PCT No.: PCT/AU10/01339

§ 371 Date: Jul. 5, 2012

(30) Foreign Application Priority Data
Oct. 12, 2009 (AU) 2009904965
Oct. 12, 2009 (AU) 2009904966

(51) Int. Cl. B29C 73/02; B05D 5/00

(52) U.S. Cl. 156/71; 427/140

(57) ABSTRACT

A method of rehabilitating or remediating a structure comprises forming a sealed region (18) over or about a portion of the structure and drawing air from the region (18). A supply of a structural adhesive is placed in fluid communication with region (18) so that as air is drawn from the region (18) the adhesive flows into the region and fills discontinuities in the structure. Fiber reinforcement or other strengthening material is placed in the region (18) so that the adhesive also penetrates through the material to band the material to the structure.

### FIELD OF THE INVENTION

The present invention relates to a method of rehabilitating or remediating structures including but not limited to load bearing made form various materials such as steel, concrete, fibre reinforced plastics (FRP) or timber. Such rehabilitation or remediation may involve for example remediation of surface and through cracks or delaminations; rebuilding of the thicknesses of a portion of the structure; reintegration of a fractured structure; to make good the structure or otherwise restore the structure to or above its designed strength.

### BACKGROUND OF THE INVENTION

The strength and integrity of structures may: be compromised at initial construction for example due to manufacturing imperfections; or, degrade in time. An example of the former is the formation of shrinkage cracks in concrete upon removal of associated formwork. Time based degradation is often due to a combination of weathering, cyclic expansion and contraction due to temperature changes, corrosion of the reinforcing steel (particularly for concrete structures), degradation of concrete through chloride and carbonation actions, dynamic loading and impact by moving objects. The degradation in the structure may be manifested by the propagation of cracks along a surface of the structure or indeed through the structure; delamination where a chunk or portion of the structure is broken off; the formation of holes through the structure; reduction in thickness, in particular wall thickness of the structure; and fracturing of the structure into two or more separate pieces. Degradation may also arise from instantaneous events such as: impact of a structure with a moving object such as a truck or ship; a fire; or natural event like an earthquake or tornado. One method of rehabilitating a structure is to fill the surface discontinuities with a filler material. This will typically involve simply troweling or injecting the filler material over or into the discontinuity. Another method of rehabilitation, particularly for a concrete structure, is to resurface the structure with a cementitious material and/or asphalt. A known method of fixing cracks or holes in steel is to cast a block of concrete around or over the effected steel area.

While such methods do cover surface imperfections or discontinuities, they often do not completely fill the discontinuities leaving pockets of air and/or moisture which weaken the bond with the structure leading to repeated failure at the original discontinuity and for concrete structures facilities continued corrosion of steel reinforcing. In addition such methods often do not restore the structure to, or near, the original design load carrying capacity.

### SUMMARY OF THE INVENTION

In one aspect the invention provides a method of rehabilitating or remediating a structure comprising:
infusing a structural adhesive into the structure.

Infusing the structural adhesive may comprise:
forming a substantially sealed region over or about at least a portion of the structure;
drawing air form the region of; and,
placing a supply of the structural adhesive in fluid communication with the region wherein the drawing of air form the region infuses the structural adhesive into the region and structure.

In a second aspect the invention provides a method of rehabilitating or remediating a structure comprising:
forming a substantially sealed region over or about at least a portion of the structure;
drawing air from the region; and,
providing a fluid communication path between a supplying structural adhesive and the region wherein structural adhesive is infused into the region and into the structure by the air drawn from the region.

In both aspects the method may comprise, prior to infusing the structural adhesive: laying a fibre reinforcing or strengthening material over the at least a portion of the structure; wherein structural adhesive infused into the region is infused into the structure through the fibre reinforcing or strengthening material.

Drawing air may comprise coupling a vacuum or relative negative pressure source at one or more locations to the region.

The air may be continuously drawn from the region.

The air may be drawn from the region at a rate quicker than a rate of air entering the region.

Drawing air from the region may comprise drawing air from the region at a rate up to 10 m³/h per meter of perimeter of the region.

Drawing air form the region may comprise providing one or more vacuum transport structures within the region and air is drawn from the region through the one or more vacuum transport structure.

Providing the one or more vacuum transport structures may comprise providing a perimeter vacuum transport structure about at least a portion of a perimeter of the region.

Providing the perimeter vacuum transport structures may comprise placing at least one first vacuum transport structure and at least one second vacuum transport structure in the region, wherein the first and second vacuum transport structures have different fluid flow characteristics.

The method may comprise providing the first vacuum transport structure as a substantially rigid forminate tubular structure.

The method may comprise providing the first vacuum transport structure as a spiral wound strip of material.

The method may comprise providing the second vacuum transport structure comprises providing a strip of fibrous material.

The method may comprise providing the second vacuum transport structure comprises providing a strip of a porous foam material.

The method may comprise a peel ply layer between the fibrous reinforcement material and the vacuum transport structures to ensure the vacuum transport structures do not get bonded into the structural adhesive.

The second vacuum transport structure may be provided with a porosity which substantially decreases when the second vacuum transport structure is wet.

The first vacuum transport structure may be provided to extend for greater than 50% of the perimeter.

In one embodiment the first vacuum transport structure is provided as two or more lengths and the second vacuum transport structure is provided between the lengths of the first vacuum transport structure to form a substantially contiguous vacuum transport structure which extends at least once about the entire perimeter.

In another embodiment the first vacuum transport structure is provided to extend completely about the perimeter of the region and the second vacuum transport structure to extend completely about the perimeter adjacent the first vacuum transport structure wherein air drawn from the region flows through the second vacuum transport structure prior to flowing into the second vacuum transport structure.

Providing the one or more vacuum transport structures may comprise providing an area vacuum transport structure which overlies the region.

The area vacuum transport structure may be provided as at least one layer of a material which facilitates transport of the structural adhesive over an entire area of the region of the structure.

The method may comprise testing the vacuum of the structure by shutting off the vacuum source and monitoring the pressure within the region. This test is often called a drop test.

At least one layer of material may be a breather layer.

Forming a substantially sealed region may comprise sealing a gas impervious cover to or about the structure.

The method may comprise forming a groove along at least a portion of the perimeter of the structure to a depth substantially equal to the depth of a crack or other discontinuity located adjacent the groove; and, filling the groove with a sealant compound.

The layer of fibrous reinforcing or strengthening material (often referred to as a dry stack laminate) may be provided as at least one layer of the following:
Glass fibre;
Carbon fibre;
Basalt fibre
Any type of polymeric fibre (e.g. aramid, polyethylene):
Any type of natural fibre (e.g. hemp, flax)
Any type of metallic fibre (e.g. steel, boron)
Wire or steel mesh

The structural adhesive may be provided as a polymeric resin, semi cementitious or cementitious grout.

The structural adhesive may be provided as an adhesive having a mixed viscosity of less than or equal to 1000 mpa·s.

The polymeric resin may be provided as one, or a mixture of two or more, of the following resins:
Epoxy resin;
Acrylate resins
Phenol resins
Benzoaxine resins
Methacrylate resins
Polyester resin;
Vinyl ester resin;
Polyurethane resin;
Polyurea resin; and,
Cyanoacrylate.

The method according may comprise, prior to the infusion, heating at least a portion of the region of the structure.

The heating may comprise heating the region to have a substantially constant surface temperature over the region.

The method may comprise curing the infused structural adhesive by application of heat to the infused structural adhesive.

The method may comprise prior to the infusing, performing one or more of the following procedures to the structure: applying a corrosion inhibitor a surface of the structure in the region; roughening the surface of the structure in the region; cleaning a surface of the structure in the region.

The substantially sealed region may be formed wholly about the structure, or wholly about a portion of the structure.

The method may comprise laying a fibre reinforcing or strengthening material wholly about the structure, or wholly about a portion of the structure within the sealed region.

The method may comprise, when the structure comprises a void in the region, filling the void prior to laying the fibre reinforcing material and wherein the fibre reinforcing material overlies the filled void.

Filling the void may comprise filling the void with one or more broken off portions of the structure.

Filling the void may comprise filling the void with one or more of a volume or piece of foam, wood, masonry material or steel.

The method may comprise, when the structure comprises a void in the region, after the infusion of structural adhesive: allowing the adhesive to cure; filling the void with a filler; laying a fibre reinforcing material over the filler and a surrounding portion of the structure, forming a substantially sealed region surrounding the fibre reinforcing material and filler; drawing air form the region; and, providing a fluid communication path between a supplying structural adhesive and the region wherein structural adhesive is infused into the region, thought the fibre reinforcing material and into the structure by the air drawn from the region.

A further aspect of the invention provides a method of applying a vacuum to a cracked or leaky structure comprising:
sealing an air tight barrier to a perimeter of a region of a structure to form a substantially sealed region; and,
drawing air from about the entire perimeter inside of the sealed gas impervious cover.

Drawing air form the region may comprise providing one or more vacuum transport structures within the region and air is drawn from the region through the one or more vacuum transport structure.

### BRIEF DESCRIPTION OF THE DRAWINGS

An embodiment of the present invention will now be described by way of example only with reference to the accompanying drawings in which:

FIG. 1 is a top elevation view of a concrete structure to which an embodiment of the method of rehabilitation is applied;

FIG. 2 is a view of section A-A of the structure shown in FIG. 1;

FIG. 3 is a section view of a concrete structure to which a second embodiment of the method has been applied.

FIG. 4 is a flow chart illustrating a first embodiment of the method of rehabilitation of a concrete structure;

FIG. 5 illustrates a second embodiment of the method for rehabilitating a concrete structure;

FIG. 6 is a plan view of a vacuum transport structure applied in a further embodiment of the present method;

FIG. 7 is a view of section B-B of the structure shown in FIG. 6;

FIG. 8 illustrates a further variation of the vacuum transport structure which may be used in performance of the present method;

FIG. 9 is a plan view of a structure illustrating a modified form of sealing step incorporated in an embodiment of the present method;

FIG. 10 is a partial section view of the structure shown in FIG. 9;

FIG. 11 illustrates an application of an embodiment of the present method to a steel reinforced concrete wall;

FIG. 12 is representation of the concrete wall shown in FIG. 11 after application of an embodiment of the present method;

FIG. 13 illustrates a portion of a steel structure in a marine environment to which an embodiment of the present method is applied; and,

FIG. 14 is a schematic representation of a structure in a tidal zone to which an embodiment of the present method is applied.

### DETAILED DESCRIPTION OF PREFERRED EMBODIMENTS

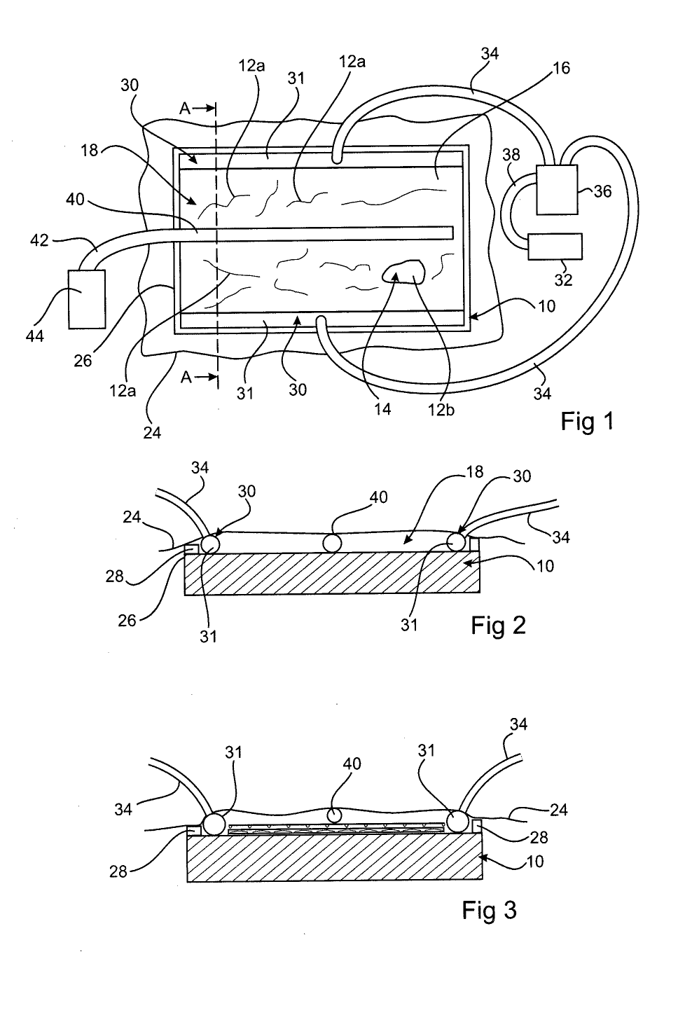

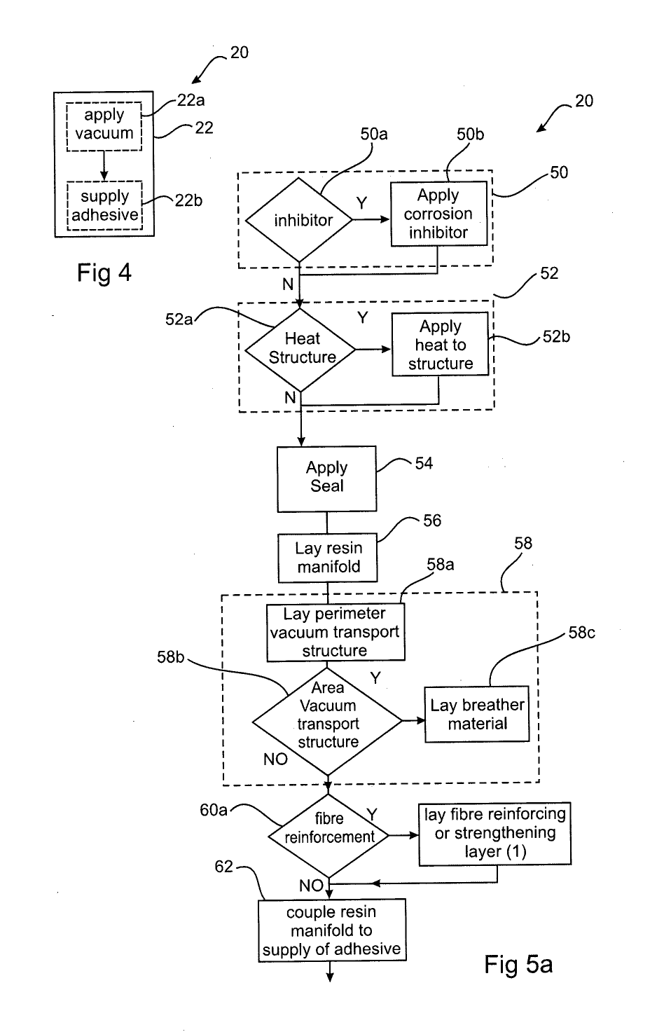

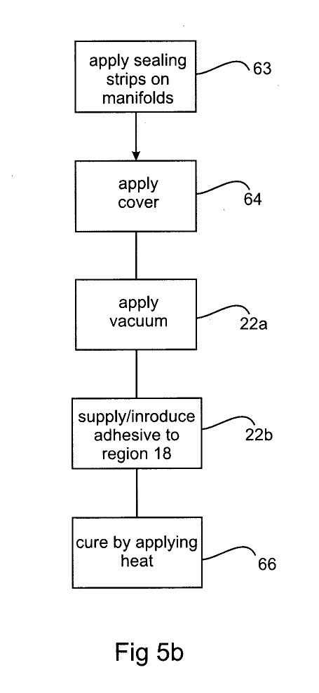

FIGS. 1 and 2 illustrate in top and side elevation view a basic set up of equipment for performing one embodiment of the method for rehabilitating or remediating a structure. For ease of description the structure in the present embodiment is described as a concrete structure 10 however the embodiments apply equally to timber, steel or structures constructed from other materials. FIG. 4 depicts very broadly a first embodiment, and FIG. 5 depicts in greater detail a second embodiment, of a method for rehabilitating a concrete structure. The concrete structure 10 is illustrated in FIGS. 1 and 2 as a slab of concrete. However this should be taken as merely representative of a portion of any concrete structure such as concrete decking of a bridge, or part of a concrete pylon. In this embodiment the concrete structure 10 is depicted as comprising a plurality of surface discontinuities which may comprise cracks 12a including surface cracks and through cracks; delaminations 12b and porosity inherent in the structure which can be treated similar to micro cracks 12a; all of which open onto a surface 16 (hereinafter referred to in general as “surface discontinuities 12”). A delamination 12b may result in the formation of a hole 14 in a surface 16 of the structure 10. However as explained hereinafter in embodiments of the invention may be applied to rehabilitate or remediate structures with significantly greater degree of facture or degradation.

With reference to FIG. 4, the method 20 of rehabilitating the concrete structure 10 in its broadest form comprises the single step 22 of infusing a structural adhesive into the surface discontinuities 12.

The term “structural adhesive” as used throughout this specification and claims is intended to denote adhesive or bonding agents that have an initial liquid or flowable state and subsequently set or cure and have the property of providing a high strength bond for a long period of time to a loaded structure. By way of example the structural adhesive may comprise a polymeric resin; or, a cementitious or semi cementitious grout; or, a combination of the two including for example an epoxy accelerated grout. To assist in its infusion the structural adhesive may having a viscosity of less than or equal to 1000 mpa·s. When the structural adhesive is in the form of a polymeric resin it may comprise one or more of the following resins:
Epoxy resin;
Acrylate resins
Phenol resins
Benzoaxine resins
Methacrylate resins
Polyester resin;
Vinyl ester resin;
Polyurethane resin;
Polyurea resin; and,
Cyanoacrylate.

Infusing the surface discontinuities 12 with the structural adhesive ensures that the discontinuities 12 are filled with the structural adhesive. Generally, the entire surface 16 will also be provided with a coating of the structural adhesive. By virtue of the infusion process, the resin fills the discontinuities 12 in a stress-free state and provides a substantially perfect repair. The use of structural adhesive provides an extremely strong bond to the concrete equaling or exceeding that of a concrete to concrete bond, and when cured, provides temperature and chemical resistance, and significantly moisture resistance for temperatures well above normal ambient temperature.

The infusion step 22 may be broken down into a step 22a of drawing air from a region 18 of the structure 10 having the surface discontinuities 12; and a step 22b of supplying the structural adhesive to be drawn into the region and thus discontinuities by the drawn air. Steps 22a and 22b are performed substantially simultaneously although there may be benefit in initially performing step 22a to at least partially evacuate the region 18 for a brief period of time before commencing step 22b. In any event the effect of these steps is to draw the structural adhesive into region 18 to fill voids in the discontinuities in the structure left by the vacating air. That is the structural adhesive takes the place of air that would otherwise reside in the discontinuities. In addition the structural adhesive is drawn into the reinforcing/strengthening material to optimise adhesive/reinforcing material ratio (also known in relation to resinous adhesives and fibre reinforcement as the resin fibre ratio).

In order to draw air from region 18 a substantially, air tight barrier or cover 24 (hereinafter referred to in general as “cover 24”) is sealed about a perimeter 26 of the region 18, and a relative negative pressure, i.e. a vacuum applied to region 18. In this instance, the perimeter 26 coincides with a peripheral edge of the surface 16 of the structure 10. The cover 24 may typically be in the form of a vacuum bag or other thin sheet or film of plastics material. The cover 24 is sealed about the perimeter 26 by use of a sealing strip 28 which extends about perimeter 26. The sealing strip 28 may comprise any strip or bead of settable liquid/gel that can form a seal on one side with the structure 10 and on an opposite side with the cover 24. Non limiting examples include pressure sensitive adhesive strip or tape such as a rubber adhesive such as AT200Y Airtech sealant tape; a double sided adhesive tape; liquid rubber or polyurethane (commonly referred to as tacky tape).

Prior to sealing the cover 24 over the region 18, a vacuum transport structure 30 is placed on the substrate 10 inside of the perimeter 26. In this embodiment, the vacuum transport structure 30 comprises a perimeter air or vacuum transport structure 31 in the form of two lengths of a rigid forminate tube, one of each extending along each of the longest two edges of the structure 10. The perimeter vacuum transport structure 31 may for example be in the form of lengths of plastic tubing provided with a plurality of holes along their length which extend radially from an outer surface of each tube to a central axial bore of that tube. In an alternate embodiment, the perimeter vacuum transport structure 31 may be in the form of one or more spiral wound tubes made from plastics material. An example product of this is ‘Spiral Guard’. The structure 30 is coupled to a relative negative pressure, hydrostatic pressure or vacuum source 32 via hoses 34 connect the tubes forming the perimeter structure 31 to a resin trap 36, and subsequently by a further hose 38 which leads to the source 32.

A resin transport structure 40, illustrated in this embodiment in the form of a manifold, extends along the region 18 midway between the tubes forming the perimeter vacuum transport structure 31. The resin transport structure 40 may be in the same form as the tubes forming the perimeter vacuum transport structure 31. The resin transport structure 40 is coupled by a hose 42 to a supply of structural adhesive 44.

The perimeter vacuum transport structure 31 and resin transport structure 40 are place on and extend over sealing strip 28 into region 18. However to reduce air leakage into region 18 additional sealing strips are applied about the outer surface of the perimeter vacuum transport structure 31 and resin transport structure 40 where they underlie sealing strip laid on the structure.

When the vacuum source 32 is applied, air is drawn from region 18 which has the effect of drawing the cover 24 onto surface 16 and drawing structural adhesive to flow from the source 44 through the hose 42 and into the resin transport structure 40 from which it then flows in opposite directions towards the perimeter vacuum transport structure 31. Accordingly as the structural adhesive flows towards perimeter vacuum transport structure 31, the pressure applied to the flowing adhesive by the cover 24 further assists in drawing the structural adhesive into the discontinuities 12. Any structural adhesive which reaches the vacuum transport structure 30 is delivered by hoses 34 into the resin trap 36 and thereby blocked from entering the vacuum source 32. Curing of the structural adhesive may be accelerated or reached by applying heat through the cover 24. The viscosity of the structural adhesive can also be controlled by applying heating or cooling to the cover 24.

It is not essential that the region 18 is perfectly sealed. Indeed it is expected that in many if not most instances a perfect seal will not be possible due to the condition of the structure 10. Air may leak into region 18 through holes or fractures in structure 10, or die to imperfections in the seal formed by sealing strip 28. What is required is that air is drawn from region 18 at a rate greater than a rate of air leakage into region 18. In one example air is drawn from region 18 at a rate of at least twice the rate of leakage into region 18. In a further embodiment air is drawn from region 18 at a rate of at least one order of magnitude greater than a rate of leakage into region 18. Thus the vacuum applied at may be determined on the basis of the density of the surface discontinuities 12. In one example it is believed that a vacuum which provides a flow rate of air from the region 18 of up to 10 m³/h per metre of perimeter may be suitable for some applications of method 20. This enables not only air or other gases within the region 18 to be evacuated but also enables: incoming air that traverse perimeter 26 or otherwise enters the region 18 via the discontinuities to also be drawn from region 18; and, the infusion of structural adhesive/resin to the extent necessary to enable an embodiment of the method 20.

In a variation of the above embodiment depicted in FIG. 3, the vacuum support structure 30 comprises both the perimeter vacuum transport structure 31, and an area vacuum transport structure 33. The area of vacuum transport structure 33 acts to transmit the vacuum across the region 18 and consequently provides a slow path for the structural adhesive. The area of vacuum transport structure 33 may be in the form of one or more layers of brief material such as, but not limited to, EnkaFusion Nylon Matting; Lantor Soric® or DIVINYMAT™ Sandwich Core Flow Media. Alternatively, the area of the vacuum transport structure may comprise one or more layers of a fibrous strengthening or reinforcing material such as grass fibre, carbon fibre, polymeric fibre, or natural fibre. Thus, the fibrous reinforcing material may act as a breather material. Alternately, both breather and fibrous reinforcing and strengthening material may be laid on the surface 16 in region 18 to assist in the transport of resin over the region 18; and/or to provide additional strengthening or reinforcements to the structure 10.

The vacuum transport structure 30 need not extend about perimeter and may comprise a manifold or pad located say in a mid portion of region 18 in addition to or instead of a perimeter vacuum transport structure.

FIG. 5 illustrates a more specific embodiment of the method 20 comprising steps which are described sequentially as follows.

The method 20 may comprise an initial site preparation step 50 relating to the preparation of the structure 10 and in particular surface 16 for application of structural adhesive and fibre reinforcing material. In this particular example this step is shown as the possible application of a corrosion inhibitor to the surface 16 of the region 18. Step 50 comprises a step 50a of deciding whether or not corrosion inhibit is required, and if so at step 50b applying the corrosion inhibitor. The corrosion inhibitor may be applied in the case that the concrete structure 10 is provided with internal steel reinforcement. The corrosion inhibitor may be applied by various methods such as spraying or applying with a brush or roller. In the event that step 50a is answered in the negative, step 50b is omitted. However surface preparation step 50 may include alternate or additional site preparation steps such as: cleaning the surface 16; roughening the surface 16; removal of loose portions of surface 16; sealing through holes in structure 10; and applying filler to voids or recesses.

Step 52 relates to the heating of the structure 10, and in particular the surface 16 in the region 18. Step 52 comprises a step 52a of deciding whether or not to heat the structure 10 and if so, at step 50b applying heat. The heating may be provided for one or both of two reasons. The first is to heat the region 18 to a uniform temperature. In this regard one or more parts of the region 18 may be at different temperatures due to for example shading from the sun. By providing a uniform temperature, the viscosity of the structural adhesive, which is temperature dependent, will be substantially the same for all portions of the region 18. The second reason for heating step 52b may be to remove moisture from the region 18 and in the discontinuities 12 prior to the application of the structural adhesive. The removal of moisture will minimise the risk of ongoing corrosion in the event that the structure 10 contains steel reinforcement, and also minimise the risk of dilution and weakening of the structural adhesive. Depending on the state of the structure 10, the heating step 52 may be applied, prior to the step 50b or both before and after step 50b.

The sealing strip 28 is then applied at step 54 to the structure 10 about the region 18. In step 56 the resin transport structure 40 is placed on the structure 10 within the region 18.

Step 58 relates to the application of the vacuum transport structure 30. The vacuum transport structure 30 may comprise one or both of the perimeter vacuum transport structure 31′ and an area vacuum transport structure 33 which overlies the entire region 18. The area transport structure is described in greater detail hereinafter. Step 58 comprises a step 58a of applying the perimeter vacuum transport structure 31 to the structure 10; a step 58b of deciding whether to apply the area vacuum transport structure; and if so at step 58c laying/applying the area vacuum transport structure. In the embodiment of FIGS. 1 and 2, the vacuum transport structure 30 is illustrated as perimeter vacuum transport structure 31′ only comprising two lengths of rigid forminate tube lying adjacent the sealing strip 28 on opposite sides of an inside the region 18 and extending along the long sides of the structure 10. In alternate embodiments (described later), the perimeter vacuum transport structure 31 may extend about the entirety of the perimeter of the region 18. In such an embodiment; the resin transport structure 40 may be modified so that its opposite ends lay spaced from the portions of the vacuum transport structure 30 that extend along the short sides of the structure 10.

In the event step 58b is answered in the affirmative then at step 58c the area vacuum transport structure 33 (See FIG. 3) is laid over the entirety of the region 18 underlying the resin transport structure 40. The area vacuum transport structure 33 may be provided as at least one layer of material which provides fluid communication between the perimeter vacuum transport structure 31 and the resin transport structure 40. This facilitates the distribution of structural adhesive over the region 18 and into the discontinuities 12. The area vacuum transport structure 33 may comprise one or more layers of a breather material.

At step 60a a determination is made as to whether to apply one or more layers of reinforcing or strengthening material 35 (See FIG. 3) to the area 18. If so then at step 60b fibrous reinforcing or strengthening material 35 may be provided as glass fibre; carbon fibre; polymeric fibre; and natural fibre is laid on the region 18. Examples of the polymeric fibre include PE, UHMWPE, PP, Aramid, while examples of the natural fibre include flax and hemp. When the structural adhesive is a cementitious grout, the strengthening material may be in the form of a large weave mesh and in particular a wire mesh, or a small gauge rebar lattice. The material 35 may also act as a breather layer and accordingly in one embodiment while a breather material 33 may otherwise be useful, if one or more layers of fibrous reinforcing material to be used in step 58c, the application of the breather material can be omitted.

At step 62, the resin transport structure 40 is coupled by the hose 42 to the supply of structural adhesive 44. However, this step 60 may be performed at the same time of performing step 56. In addition, if desired the resin transport structure 40 may be coupled to the supply 44 of structural adhesive at a plurality of different locations. For example at opposite ends of the transport structure 40, or in the middle of the transport structure 40.

At step 63 additional sealing strips are applied about the outer surface of perimeter vacuum transport structure 31 and resin transport structure 40 at locations coincident with perimeter 26.

At step 64, the cover 24 is laid over the region 18 and coupled to the sealing strip 28 laid on surface 16 and on the outer surface of perimeter vacuum transport structure 31 and resin transport structure 40. The cover 24 is applied loosely over the region 18 so that upon application of the vacuum, the cover 24 can be drawn onto the surface 16 of the region 18. Next, at step 22a air is drawn from region 18 by coupling the vacuum pump 32 via hose 38, resin trap 36 and hoses 34 to the perimeter vacuum transport structure 30. This involves passing the tubes 34 through the cover 24 and subsequently coupling the tubes 34 with the structure 30. Holes formed through the cover 24 to allow the passage of the hoses 34 are sealed to prevent leakage of air about the hoses 34 into the region 18.

Upon application of the vacuum at step 22a, the structural adhesive 44 is supplied or otherwise introduced into the region 18 at step 22b via the resin transport structure 40. However a valve may be placed in hose 42 which is initially closed to allow at least partial drawing of air form region 18 prior to allowing the structural adhesive to be drawn into region 18. Thereafter the valve may be opened to enable the structural adhesive to be drawn into region 18.

Once structural adhesive has flowed across the entirety of the region 18 reaching the perimeter vacuum transport structure 30 the supply of adhesive can be shut. This may be achieved by closing the valve in hose 42. The vacuum source may be maintained for a period of time while curing occurs to continually draw air that leaks into region 18. However during this period the vacuum is reviewed and may be varied, and in particular reduced so as to not draw the adhesive from the region 18 while the structural adhesive is curing. Curing of the structural adhesive may be accelerated or reached by application of heat at step 66 through the cover 24. The heat may be applied by use of electric blankets, infra red radiation, hot air or steam.

Following the curing of the structural adhesive, the vacuum source can be disconnected or shut off and the cover 24, perimeter vacuum transport structure 30, resin transport structure 40, and sealing strip 28 removed. If a breather layer is incorporated as an upper most layer of the area vacuum transport structure, and has not been permanently adhered by the structural adhesive, and it is desired to do so, it may be removed.

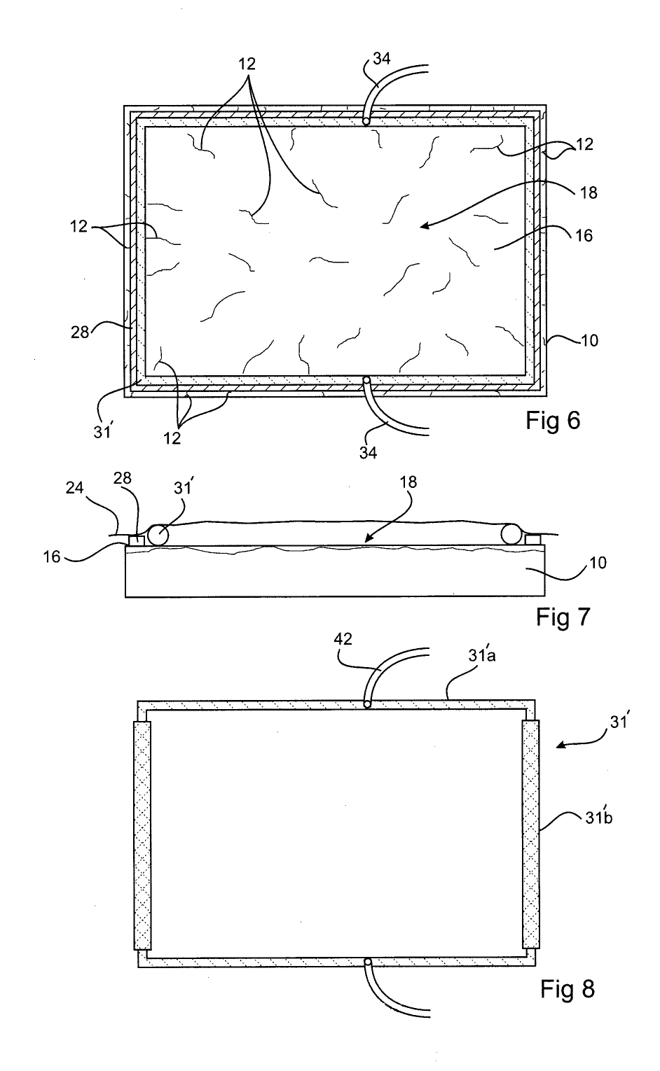

In the above described embodiment the air or vacuum transport structure 30 is described as comprising perimeter vacuum transport structure 31 in the form of two lengths of a rigid forminate tube, one of each extending along each of the longest two edges of the structure 10. However an alternate perimeter vacuum transport structure 31′ and associated method of sealing a region of a structure is illustrate in FIGS. 6 to 10.

The substantive differences between the perimeter vacuum transport structures 31 and 31′ is that the perimeter vacuum transport structure 31′ extends wholly about the perimeter 26 to in effect form a ring main. In addition perimeter vacuum transport structure 31′ may be provided as either a first transport structure 31′a; a second transport structure 31′b; or, a combination of the first and second transport structures 31′a and 31′b, where the first and second transport structures 31′a, 31′b have different fluid flow characteristics.

The first vacuum transport structure 31′a is in the form of a rigid manifold provided with a plurality of openings or holes, similar to structure 31. Examples of such structures include: a forminate tubular structure; such as a plastic or metal tube provided with a plurality of radially extending holes or a longitudinal groove or slit that communicate with a central bore of the tube; a rolled wire mesh, or a spiral wound strip of material sometimes known as spiral tubing.

The second form of vacuum transport structure 31′b is in the form of a strip or length of compliant fibrous or porous foam material. Examples of such materials include weaved natural or synthetic fibres such as a length of woven cotton or wool, or shade cloth or Hessian; Enkamat® manufactured by Colbond or a strip of sponge foam. When the vacuum transport structure 31′ comprises a combination of structures 31′a and 31′b, the structures 31′a and 31′b are in fluid communication with each other about the perimeter 26 so that a vacuum applied at any one or more points about the structure 31′ is communicated about the entire internal perimeter of the region 18. This enables the vacuum to be applied about the entire perimeter of a region 18. The first, i.e. rigid, vacuum transport structure 31′a may be applied to extend for more than 50% of the perimeter 26 of the region 18. For example as illustrated in FIGS. 6 and 7, the vacuum transport structure 31′ comprises only the rigid vacuum transport structure 31′a and extends wholly about the perimeter. In another variation shown in FIG. 8, the vacuum transport structure 31′ may comprise a single or multiple (in this case two) lengths of the first structure 31′a which extend for a total of >50% of the perimeter, and a single or multiple (In this case two) lengths of the second structure 31′b which are joined end to end so that the structure 31′ extends once about the entire perimeter 26 of the region 18. In yet a further variation, the first structure 31′a extends entirely about the perimeter 26, and a second structure 31′b which also extends entirely about the perimeter 26 and is adjacent a structure 31′a so that air extracted from the region 18 by the vacuum passes through the structure 31′b prior to passing through the structure 31′a.

The structure 31′b may also be chosen to have a porosity which substantially decreases when wet. The characteristic of decreasing porosity when wet may be beneficial in various applications of the method 20 where it may be desired to control the flow rate of fluids in a particular area in a region 18 which is subject to the applied vacuum.

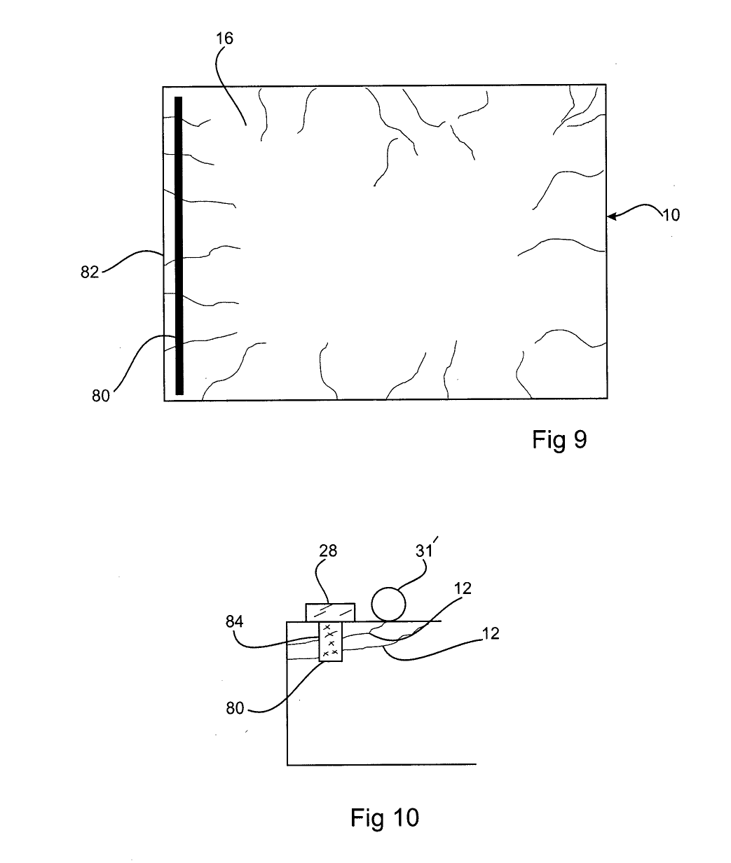

In terms of sealing the cover 24 over the region 18, an initial step of assessing likely leakage rates from the region 18 is made. In the event that it is determined that the structure 10 comprises a sufficient density or size of discontinuities in the region 18 to compromise the seal to an extend of adversely affect the ability to draw air from and adhesive into region 18, an additional sealing step of cutting a groove in the structure and subsequently filling the groove may be applied. This is shown in particular with reference to FIGS. 9 and 10. These figures illustrate a groove 80 cut vertically into the surface 16 of the structure 10 slightly inboard of an edge 82. To enhance effectiveness the groove 80 is cut to a depth equal to or greater than the deepest discontinuity 12 which traverses the perimeter 26. The groove 80 is filled with a sealant compound 84. The material 84 may for example be a settable polyester sealant or plastic putty such as commercial automotive filler. The groove 82 may be cut about the entire perimeter 26 or only along one or more lengths of the perimeter 26 as required. The sealant strip 28 may be applied over the filled, groove 80 and the remainder of the method 20 performed as described above.

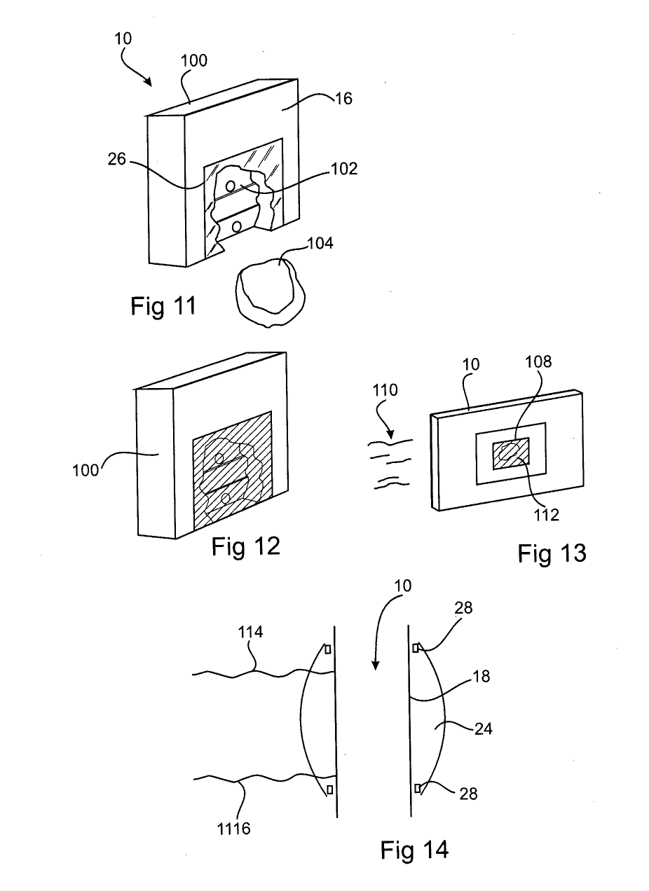

FIGS. 11 and 12 depict a further application of method 20 for rehabilitating a structure 10. In this instance, the structure 10 comprises a concrete wall 100 provided with internal steel reinforcement in the form of lengths of rebar 102. A large section 104 of wall 100 has broken off creating a void 106 and exposing rebar 102. In applying method 20, in the site preparation step 50, the surface 16 may be cleaned for example with a wire brush to remove loose surface portions and followed with the application of a corrosion particularly to the rebar 102. Subsequently, each step of method 20 from and including step 54 are performed with step 60a being answered in the negative in which case no further reinforcing material is laid on the surface. Thus in this instance, the region 28 under cover 24 is infused with structural adhesive. This has the effect of bringing together or reintegrating the standing portion of wall 100 and providing a further barrier to corrosion of rebar 102. However, the void or recess 106 remains where section 104 has fallen from wall 100. To complete the rehabilitation of wall 100 section 194 may now be reinserted into void 106 as best as possible. In most instances, this will not be a perfect fit and gaps are expected to exist between the section 104 and surrounding portions of concrete wall 100. If desired, additional filler may be inserted into such gaps. With the section 104 now substantially filling void 106, method 20 is applied again to the concrete wall 100 starting from step 54 shown in FIG. 5a but this time with step 60a answered in the affirmative wherein a layer of fibre reinforcing material is laid over section 104 and a surrounding area of surface 16. Thus the structure 100 has now been essentially completely rehabilitated and reintegrated as a single structure having structural characteristics similar or better than the original structure 100 prior to degradation.

Thus, in the above example described with reference to FIGS. 11 and 12, two variations of method 20 are applied sequentially to structure 10. In the event that section 104 was not available, for example in the event that structure 10 is part of a bridge spanning a body of water where section 104 has fallen into the body and cannot be practically retrieved, an alternate filler may be inserted into void 106.

FIG. 13 illustrates a further application of method 20. Here method 20 is applied to a steel structure 10 in a marine environment. The structure 10 may for example be the hull of a ship or body of a buoy. A portion of structure 10 has corroded to substantially reduce the thickness of structure 10 and in one location is corroded to the extent that a hole 108 is formed through the structure 10 allowing ingress of water from ocean 110. In applying method 20, at the initial surface preparation step 50, hole 108 is sealed with at least a temporary sealant such as a timber plug and/or plasticine. Next the site preparation step 50 comprises in this example adhesively bonding a doubler plate 112 over the sealed hole 108. The purpose of this is to ensure sealing of hole 108 to prevent ingress of water and to enable in effect restoration of the original thickness of structure 10 in an area surrounding, hole 108. A further, preparation step of roughening surface 16 of structure 10 about upper plate 112 may be performed. This may be achieved for example by use of air grinding and needle scalers. Subsequent to the site preparation step 50, each of steps 54-66 of method 20 as shown in FIG. 5a is applied. In this example, step 60a is answered in the affirmative so that fibre reinforcing material is applied to region 18.

FIG. 14 illustrates yet a further application of method 20 to a structure 10 in the form of a supporting column in a tidal zone. The supporting column may be made from any material such as concrete, concrete with steel reinforcing, steel, or timber. Here however the region 18 requiring rehabilitation or remediation is, substantially under a high tide level 114 although it is exposed at low tide level 116. Surface preparation step 50, if applied in method 20 will be performed when the tide is out so that water level is at the low tide level 116. The surface preparation may comprise cleaning of surface 16 of structure 10 for example to de-scale the surface and remove any marine organisms on surface 16. Next steps 54-64 of method 20 shown in FIG. 5a are performed while the water is at the low tide level 116. The sealing steps 54 and 63 ensure that water is unable to flow into region 18 when above the low tide level 116.

Step 22a may be applied while the water level is at the low tide level 116 or as water level is rising toward high tide level 114. Additional benefit may be derived by delaying step 22b, namely infusion of the structural-adhesive, until after the water level has reached the high tide level 114. This benefit arises from application of water pressure to the structural adhesive and any fibre reinforcing material surrounding region 18 as the consolidation of the adhesive and reinforcing material is improved. The water pressure may further assist in penetration of structural adhesive into structure 10. By forming the vacuum transport structure in a manner that complete surrounds the perimeter of region 18, water which may leak past sealing strip 28 can be drawn substantially immediately from region 18 thereby minimising any adverse effect of water seepage.

Modifications and variations to the above described method as would be obvious to persons of ordinary skill in the art are deemed to be, within the scope of the present invention the nature of which is to be determined from the above description and the appended claims.

The claims defining the invention are as follows:

1. A method of rehabilitating or remediating a structure comprising:
infusing a structural adhesive into the structure.

2. The method according to claim 1 wherein infusing a structural adhesive comprises:
forming a substantially sealed region over or about at least a portion of the structure;
drawing air form the region of; and,
placing a supply of the structural adhesive in fluid communication with the region wherein the drawing of air form the region infuses the structural adhesive into the region and structure.

3. A method of rehabilitating or remediating a structure comprising:
forming a substantially sealed region over or about at least a portion of the structure;
drawing air from the region; and,
providing a fluid communication path between a supplying structural adhesive and the region wherein structural adhesive is infused into the region and into the structure by the air drawn from the region.

4. The method according to any one of claims 1 to 3 comprising, prior to infusing the structural adhesive: laying a fibre reinforcing or strengthening material over the at least a portion of the structure; wherein structural adhesive infused into the region is infused into the structure through the fibre reinforcing or strengthening material.

5. The method according to any one of claims 2 to 4 wherein drawing air comprises coupling a vacuum or relative negative pressure source at one or more locations to the region.

6. The method according to any one of claims 2 to 5 wherein air is continuously drawn from the region.

7. The method according to any one of claims 2 to 6 wherein air is drawn from the region at a rate quicker than a rate of air entering the region.

8. The method according to any one of claims 2 to 7 wherein drawing air from the region comprises drawing air from the region at a rate of 0 to 10 m³/h per meter of perimeter of the region.

9. The method according to any one of claims 2 to 8 wherein drawing air form the region comprises providing one or more vacuum transport structures within the region and air is drawn from the region through the one or more vacuum transport structure.

10. The method according to claim 9 wherein providing the one or more vacuum transport structures comprises providing a perimeter vacuum transport structure about at least a portion of a perimeter of the region.

11. The method according to claim 10 wherein providing the perimeter vacuum transport structures comprises placing at least one first perimeter vacuum transport structure and at least one second perimeter vacuum transport structure in the region, wherein the first and second perimeter vacuum transport structures have different fluid flow characteristics.

12. The method according to claim 11 comprising providing the first perimeter vacuum transport structure as a substantially rigid forminate tubular structure.

13. The method according to claim 11 comprising providing the first perimeter vacuum transport structure as a spiral wound strip of material.

14. The method according to any one of claims 11 to 13 comprising providing the second perimeter vacuum transport structure comprises providing a strip of fibrous material.

15. The method according to any one of claims 11 to 13 comprising providing the second perimeter vacuum transport structure comprises providing a strip of a porous foam material.

16. The method according to any one of claims 11 to 15 comprising providing the second perimeter vacuum transport structure with a porosity which substantially decreases when the second vacuum transport structure is wet.

17. The method according to any one of claims 10 to 16 wherein the first vacuum transport structure is provided to extend for greater than 50% of the perimeter.

18. The method according to any one of claims 10 to 17 wherein the first vacuum transport structure is provided as two or more lengths and the second vacuum transport structure is provided between the lengths of the first vacuum transport structure to form a substantially contiguous vacuum transport structure which extends at least once about the entire perimeter.

19. The method according to any one of claims 10 to 17 wherein the first vacuum transport structure is provided to extend completely about the perimeter of the region and the second vacuum transport structure to extend completely about the perimeter adjacent the first vacuum transport structure wherein air drawn from the region flows through the second vacuum transport structure prior to flowing into the second vacuum transport structure.

20. The method according to any one of claims 9 to 19 wherein providing the one or more vacuum transport structures comprises providing an area vacuum transport structure which overlies the region.

21. The method according to claim 20 wherein the area vacuum transport structure is provided as at least one layer of a material which facilitates transport of the structural adhesive over an entire area of the region of the structure.

22. The method according to claim 21 wherein the at least one layer of material comprises: at least one layer of breather material; at least one layer of the reinforcing or strengthening material; or, a combination of at least one layer of breather material and at least one layer of the reinforcing or strengthening material.

23. The method according to any one of claims 2 to 22 wherein forming a substantially sealed region comprises sealing a gas impervious cover to or about the structure.

24. The method according to claim 23 comprising forming a groove along at least a portion of the perimeter of the structure to a depth substantially equal to the depth of a crack or other discontinuity located adjacent the groove; and, filling the groove with a sealant compound.

25. The method according to any one of claims 4 to 24 wherein providing the layer of fibrous reinforcing or strengthening material comprises providing at least one layer of material which contains at least one of the following:
Glass fibre;
Carbon fibre;
Basalt fibre
Wire or steel mesh
Any type of polymeric fibre (e.g. aramid, polyethylene):
Any type of natural fibre (e.g. hemp, flax)
Any type of metallic fibre (e.g steel, boron)

26. The method according to any one of claims 1 to 25 wherein the infusing a structural adhesive comprises providing the structural adhesive as a polymeric resin or cementitious grout or other variants such as epoxy accelerated grout.

27. The method according to any one of claims 1 to 26 wherein the structural adhesive is provided as an adhesive having a mixed viscosity of less than or equal to 1000 mpa·s.

28. The method according to claim 26 or 27 wherein providing the structural adhesive as a polymeric resin comprises providing the polymeric resin as a resin which comprises one or more of the following resins:
Epoxy resin;
Acrylate resins
Phenol resins
Benzoaxine resins
Methacrylate resins.
Polyester resin;
Vinyl ester resin;
Polyurethane resin;
Polyurea resin; and,
Cyanoacrylate.

29. The method according to any one of claims 1 to 28 comprising, prior to the infusion, heating at least a portion of the region of the structure.

30. The method according to any claim 29 wherein the heating comprises heating the region to have a substantially constant surface temperature over the region.

31. The method according to any one of claims 1 to 30 comprising curing the infused structural adhesive by application of heat to the infused structural adhesive.

32. The method according to any one of claims 1 to 31 comprising prior to the infusing, performing one or more of the following procedures to the structure: applying a corrosion inhibitor a surface of the structure in the region; roughening the surface of the structure in the region; cleaning a surface of the structure in the region.

33. The method according to any one of claims 2 to 32 wherein the substantially sealed region is formed wholly about the structure, or wholly about a portion of the structure.

34. The method according to claim 33 comprising laying a fibre reinforcing material wholly about the structure; or wholly about a portion of the structure within the sealed region.

35. The method according to any one of claims 4 to 34 comprising, when the structure comprises a void in the region, filling the void prior to laying the fibre reinforcing material and wherein the fibre reinforcing material overlies the filled void.

36. The method according to claim 35 wherein filling the void comprises filling the void with one or more broken off portions of the structure.

37. The method according to claim 35 wherein filling the void comprises filling the void with one or more of a volume or piece of foam, wood, masonry material or steel.

35. The method according to any one of claims 1 to 3, 5 to 24 except when dependant on claims 4, 26 to 33 except when dependant on claim 4 or 25 comprising, when the structure comprises a void in the region, after the infusion of structural adhesive: allowing the adhesive to cure; filling the void with a filler; laying a fibre reinforcing material over the filler and a surrounding portion of the structure, forming a substantially sealed region surrounding the fibre reinforcing material and filler; drawing air form the region; and, providing a fluid communication path between a supplying structural adhesive and the region wherein structural adhesive is infused into the region, thought the fibre reinforcing material and into the structure by the air drawn from the region.

36. The method according to any one of claims 1 to 35 comprising controlling viscosity of the structural adhesive by heating or cooling the structural adhesive during the infusion of the adhesive.

37. A method of applying a vacuum to a cracked or leaky structure comprising:
sealing an air tight barrier to a perimeter of a region of a structure to form a substantially sealed region; and;
drawing air from about the entire perimeter inside of the sealed gas impervious cover.

38. The method according to claim 37 wherein drawing air form the region comprises providing one or more vacuum transport structures within the region and air is drawn from the region through the one or more vacuum transport structure.

39. The method according to claim 38 wherein providing the one or more vacuum transport structures comprises providing a perimeter vacuum transport structure about at least a portion of a perimeter of the region.

40. The method according to claim 39 wherein providing the perimeter vacuum transport structures comprises placing at least one first perimeter vacuum transport structure and at least one second perimeter vacuum transport structure in the region, wherein the first and second perimeter vacuum transport structures have different fluid flow characteristics.

41. The method according to claim 40 comprising providing the first perimeter vacuum transport structure as one or more of: a substantially rigid forminate tubular structure; a spiral wound strip of material; or a rolled wire mesh.

42. The method according to claim 40 or 41 comprising providing the second perimeter vacuum transport structure as one or more of: a strip of fibrous material; and, a strip of a porous foam material.

43. The method according to any one of claims 40 to 42 comprising providing the second perimeter vacuum transport structure with a porosity which substantially decreases when the second perimeter vacuum transport structure is wet.

44. The method according to any one of claims 40 to 43 wherein the first perimeter vacuum transport structure is provided as two or more lengths and the second perimeter vacuum transport structure is provided between the lengths of the first perimeter vacuum transport structure to form a substantially contiguous vacuum transport structure which extends at least once about the entire perimeter.

45. The method according to any one of claims 40 to 43 wherein the first perimeter vacuum transport structure is provided to extend completely about the perimeter of the region and the second perimeter vacuum transport structure to extend completely about the perimeter adjacent the first perimeter vacuum transport structure wherein air drawn from the region flows through the second perimeter vacuum transport structure prior to flowing into the first perimeter vacuum transport structure.
